(19) United States
(12) Patent Application Publication
(10) Pub. No.: US 2024/0371062 A1
(43) Pub. Date: Nov. 7, 2024

(54) CONTENT EVALUATION DEVICE, PROGRAM, METHOD, AND SYSTEM

(71) Applicant: Wacom Co., Ltd., Saitama (JP)

(72) Inventors: Nobutaka IDE, Saitama (JP); Hiroshi TAMANO, Saitama (JP); Bunta TAUCHI, Saitama (JP); Jin-Fu KO, Saitama (JP)

(21) Appl. No.: 18/773,310

(22) Filed: Jul. 15, 2024

Related U.S. Application Data
(63) Continuation of application No. PCT/JP2022/043621, filed on Nov. 25, 2022.

(30) Foreign Application Priority Data
Jan. 31, 2022 (JP) 2022-013012

(51) Int. Cl. G06T 11/60; G06T 11/20; G06T 11/40

(52) U.S. Cl. CPC G06T 11/60; G06T 11/203; G06T 11/206; G06T 11/40; G06T 2200/24

(57) ABSTRACT

A content evaluation device includes a feature calculating section that calculates a state feature amount relating to a drawing state in a creation period from a start timing to an end timing of creation of content, and a display instructing section. The display instructing section instructs displaying of picture-print information indicating a picture-print, which is a set or a trace of points in a feature space for representing the state feature amount calculated by the feature calculating section, or displaying of derived information derived from the picture-print.

### BACKGROUND

### Technical Field

The present disclosure relates to content evaluation device, program, method, and system.

### Description of the Related Art

Conventionally a technique using a computer system to allow multiple users to share digital content which is an intangible object (hereinafter, simply referred to also as “content”) is known (see, for example, Japanese Patent No. 6734502).

### BRIEF SUMMARY

For example, by providing inspiration to users such as a content creator and a content viewer, it becomes possible to expect generation of a “positive spiral” of art creation activities.

The present disclosure is directed to providing content evaluation device, program, method, and system, which can provide effective inspiration to users such as a content creator and a convent viewer, leading to creation of future content.

A content evaluation device according to a first aspect of the present disclosure includes a feature calculating section that calculates a state feature amount relating to a drawing state in a creation period from a start timing to an end timing of creation of content, and a display instructing section that instructs displaying of picture-print information indicating a picture-print, which is a set or a trace of points in a feature space for representing the state feature amount calculated by the feature calculating section, or displaying of derived information derived from the picture-print.

A content evaluation program according to a second aspect of the present disclosure causes one or multiple computers to execute calculating a state feature amount relating to a drawing state in a creation period from a start timing to an end timing of creation of content, and instructing displaying of picture-print information indicating a picture-print, which is a set or a trace of points in a feature space for representing the state feature amount, or displaying of derived information derived from the picture-print.

A content evaluation method according to a third aspect of the present disclosure, executed by one or multiple computers, includes calculating a state feature amount relating to a drawing state in a creation period from a start timing to an end timing of creation of content, and instructing displaying of picture-print information indicating a picture-print, which is a set or a trace of points in a feature space for representing the state feature amount, or displaying of derived information derived from the picture-print.

A content evaluation system according to a fourth aspect of the present disclosure includes a user device having a display device that displays an image or video, and a server device configured capable of communicating with the user device. The server device includes a feature calculating section that calculates a state feature amount relating to a drawing state in a creation period from a start timing to an end timing of creation of content, and a display instructing section that instructs the user device to display picture-print information indicating a picture-print, which is a set or a trace of points in a feature space for representing the state feature amount calculated by the feature calculating section, or to display derived information derived from the picture-print.

According to the present disclosure, effective inspiration leading to creation of future content can be provided to users including a content creator and a content viewer.

### BRIEF DESCRIPTION OF THE SEVERAL VIEWS OF THE DRAWINGS

FIG. 1 is an overall configuration diagram of a content evaluation system in one embodiment of the present disclosure;

FIG. 2 is a block diagram illustrating one example of the configuration of a server device of FIG. 1;

FIG. 3 is a detailed functional block diagram of a feature calculating section illustrated in FIG. 2;

FIG. 4 is a flowchart illustrating one example of a calculation operation of feature information by the server device;

FIG. 5 is a diagram illustrating one example of content created by using the user device of FIG. 1;

FIG. 6 is a diagram illustrating the transition of the drawing state of an artwork of FIG. 5;

FIG. 7 is a diagram illustrating one example of a data structure of content data of FIG. 1 and FIG. 2;

FIG. 8 is a diagram illustrating one example of a data structure of graph data of FIG. 3;

FIG. 9 is a diagram illustrating one example of a data structure of picture-print data;

FIG. 10 is a diagram illustrating one example of a calculation method of a state feature amount;

FIG. 11 is a diagram illustrating one example of a calculation method of an operation feature amount;

FIG. 12 is a diagram illustrating one example of a picture-print made visible;

FIG. 13 is a flowchart illustrating one example of a reproduction display operation of content;

FIG. 14 is a diagram illustrating one example of a content reproduction screen displayed on a display of FIG. 1;

FIG. 15 is a diagram illustrating a first example of an inspiration display;

FIG. 16 is a diagram illustrating a second example of an inspiration display;

FIG. 17 is a diagram illustrating one example of a selection method of a directly related word;

FIG. 18 is a diagram illustrating one example of a selection method of an indirectly related word in a third example of an inspiration display;

FIG. 19 is a diagram illustrating a fourth example of an inspiration display; and

FIG. 20 is a diagram illustrating one example of a data structure of representation conversion data.

### DETAILED DESCRIPTION

Embodiments of the present disclosure will be described below with reference to the accompanying drawings. To facilitate understanding of the description, the same constituent element is given the same numeral as much as possible in the respective drawings, and overlapping description is omitted.

### Configuration of Content Evaluation System 10

### Overall Configuration

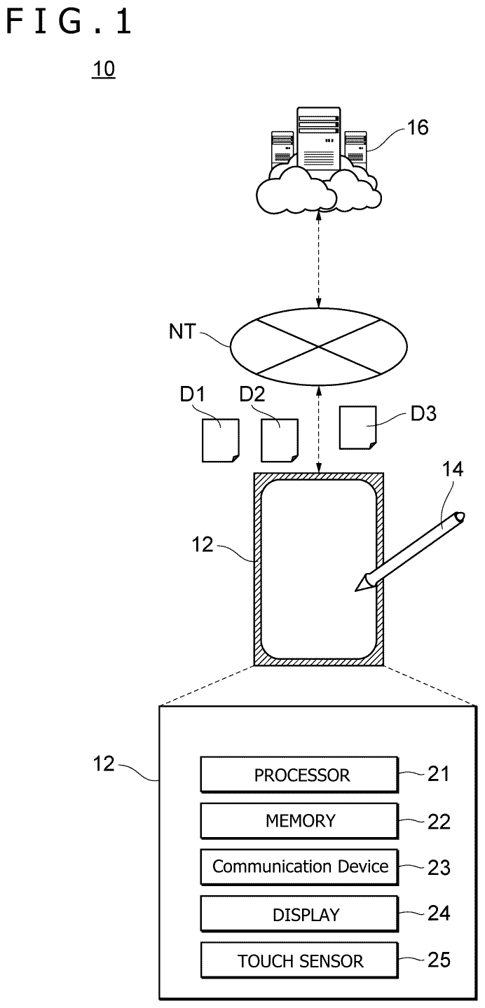

FIG. 1 is an overall configuration diagram of a content evaluation system 10 in one embodiment of the present disclosure. The content evaluation system 10 is configured to provide a “content evaluation service” for evaluating computerized content (generally called “digital content”). Specifically, the content evaluation system 10 includes one or multiple user devices 12, one or multiple electronic pens 14, and a server device 16 (corresponding to a “content evaluation device”). Each user device 12 and the server device 16 are connected to be communicable through a network NT.

The user device 12 is a computer owned by a user (a content creator, for example) who uses the content evaluation service, and may be, for example, a tablet, a smartphone, a personal computer, or the like. Each user device 12 is configured to be capable of generating “content data” D1 and “related data” D2, to be described later, and supplying various types of data generated by the user device 12 to the server device 16 through the network NT. Specifically, the user device 12 includes a processor 21, a memory 22, a communication device 23, a display 24, and a touch sensor 25.

The processor 21 includes a computation processing device such as a central processing unit (CPU), a graphics processing unit (GPU), and a micro-processing unit (MPU). The processor 21 executes various processing such as generation processing to generate ink data (hereinafter referred to also as “digital ink”) that describes content, and rendering processing to cause display of content represented by digital ink, by reading out a program and data stored in the memory 22.

The memory 22 stores the programs and data necessary for the processor 21 to control the various constituent elements. The memory 22 is configured from a non-transitory computer-readable storage medium. Here, the computer-readable storage medium is configured from [1] a storage device such as a hard disk (HDD) or a solid state drive (SSD) incorporated in a computer system, [2] a portable medium such as a magneto-optical disc, a read only memory (ROM), a compact disk (CD)-ROM, or a flash memory, or the like.

The communication device 23 has a communication function to perform wired communication or wireless communication with an external device. This allows the user device 12 to, for example, exchange various kinds of data with the server device 16 such as the content data D1, the related data D2, or presentation data D3.

The display 24 can visibly display content including an image or video, and is configured from a liquid crystal panel, an organic electro-luminescence (EL) panel, or electronic paper, for example. Configuring the display 24 to be flexible allows the user to perform various writing operations on a touch surface of the user device 12 which is in a curved or bent state.

The touch sensor 25 is a sensor of a capacitive system obtained by disposing multiple sensor electrodes in a planner manner. For example, the touch sensor 25 includes multiple X line electrodes for detecting a position along an X-axis of a sensor coordinate system and multiple Y line electrodes for detecting a position along a Y-axis. The touch sensor 25 may be a sensor of the self-capacitance system in which block-shaped electrodes are disposed in a two-dimensional lattice manner, instead of the above-described sensor of the mutual capacitance system.

The electronic pen 14 is a pen-type pointing device and is configured to be capable of unidirectionally or bidirectionally communicating with the user device 12. For example, the electronic pen 14 is a stylus of the active capacitance type (AES) system or the electromagnetic resonance (EMR) system. The user can draw pictures, write characters (text), and so forth, on the user device 12 by gripping the electronic pen 14 and moving the electronic pen 14 while pressing the pen tip against the touch surface of the user device 12.

The server device 16 is a computer that executes comprehensive control relating to evaluation of content and may be either a cloud type server or an on-premise type server. Here, the server device 16 is illustrated as a single computer. However, the server device 16 may instead be a computer group that forms a distributed system.

### Block Diagram of Server Device 16

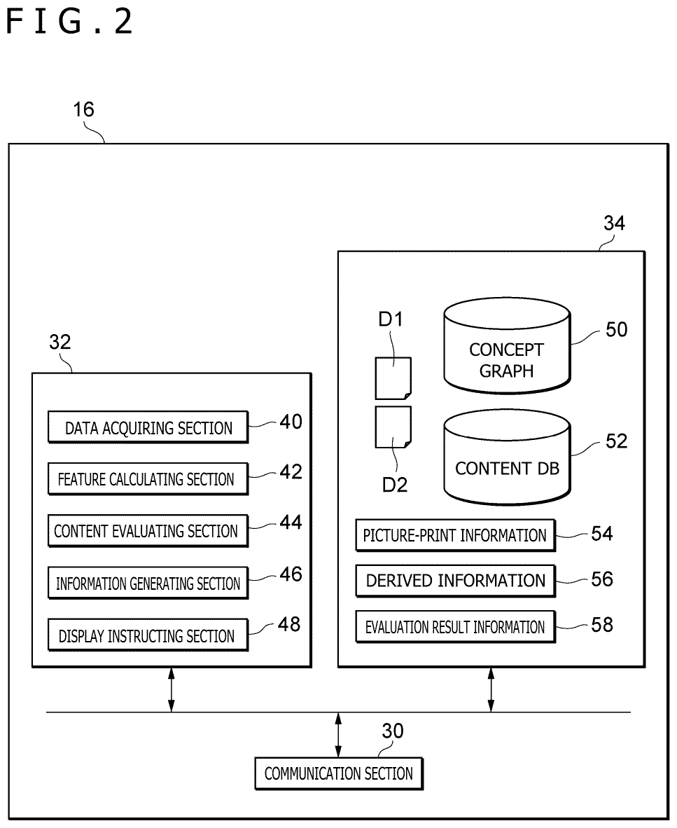

FIG. 2 is a block diagram illustrating one example of a configuration of the server device 16 of FIG. 1. Specifically, the server device 16 includes a communication section 30, a control section 32, and a storing section 34.

The communication section 30 is an interface that transmits and receives an electrical signal to and from an external device. This allows the server device 16 to acquire at least one of the content data D1 and the related data D2 from the user device 12 and to provide the presentation data D3 generated by the server device 16 to the user device 12.

The control section 32 is configured by a processor such as a CPU and a GPU. The control section 32 functions as a data acquiring section 40, a feature calculating section 42, a content evaluating section 44, an information generating section 46, and a display instructing section 48, by reading out a program and data stored in the storing section 34 and executing the program.

The data acquiring section 40 acquires various kinds of data (for example, content data D1, related data D2, and so forth) relating to content that is an evaluation target. The data acquiring section 40 may acquire various kinds of data from an external device through communication or acquire various kinds of data through reading them out from the storing section 34.

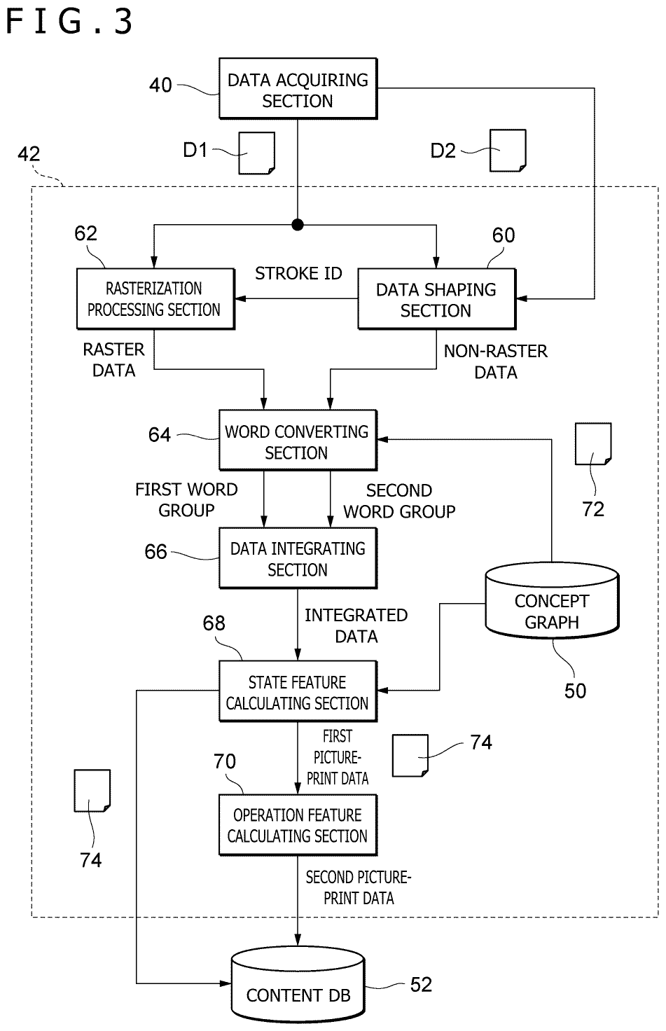

The feature calculating section 42 calculates a feature amount relating to content, from at least one of the content data D1 or the related data D2 acquired by the data acquiring section 40. In a feature amount, either of [1] a feature amount relating to the drawing state of the content (hereinafter referred to as “state feature amount”) or [2] a feature amount relating to individual operations executed to create the content (hereinafter referred to as “operation feature amount”) is included. The specific configuration of the feature calculating section 42 will be described in detail in FIG. 3.

The content evaluating section 44 executes evaluation processing to evaluate content by using a time series of the state feature amounts or the operation feature amounts calculated by the feature calculating section 42. For example, the content evaluating section 44 evaluates [1] the style of content, [2] creator's habit, [3] the psychological state of the creator, or [4] the state of the external environment. Here, the “style” means individuality or philosophy of the creator expressed in the content. Examples of the “habit” include use of color, drawing tendency regarding a stroke, usage tendency regarding equipment, the degree of an operation error, and so forth. Examples of the “psychological state” include, besides emotions such as delight, anger, sorrow, and pleasure, various states such as drowsiness, relaxation, and nervousness. Examples of the “external environment” include the ambient brightness, cold or warm, the weather, the season, and so forth.

Further, the content evaluating section 44 obtains the degree of similarity between the time series of feature amounts corresponding to content of an evaluation target (that is, a first time series of feature amounts) and the time series of feature amounts corresponding to authentic content (that is, a second time series of feature amounts) and determines the authenticity of the content of the evaluation target on the basis of the degree of similarity. For the degree of similarity, for example, various indexes are used such as a correlation coefficient, a norm, and so forth.

Moreover, the content evaluating section 44 can use the time series of state feature amounts or operation feature amounts calculated by the feature calculating section 42 to estimate the kind of creation step corresponding to the drawing state of content. Examples of the kind of creation step include a composition step, a line drawing step, a coloring step, a finishing step, and so forth. In addition, the coloring step may be subdivided into an underpainting step, a main painting step, and so forth, for example.

The information generating section 46 generates picture-print information 54 or derived information 56, to be both described later, by using the time series of various feature amounts (more specifically, state feature amounts or operation feature amounts) calculated by the feature calculating section 42. Alternatively, the information generating section 46 generates evaluation result information 58 indicating the evaluation result of the content evaluating section 44.

The display instructing section 48 gives an instruction to display the information generated by the information generating section 46. The “display” includes, besides the case of displaying the information on an output device (not illustrated) disposed in the server device 16, the case of transmitting the presentation data D3 including the picture-print information 54, the derived information 56, or the evaluation result information 58 to an external device such as the user device 12 (FIG. 1).

The storing section 34 stores the programs and data necessary for the control section 32 to control the respective constituent elements. The storing section 34 is configured of a non-transitory computer-readable storage medium. Here, the computer-readable storage medium is configured of [1] a storage device such as an HDD or an SSD incorporated in a computer system, [2] a portable medium such as a magneto-optical disc, a ROM, a CD-ROM, or a flash memory, or the like.

In the example of FIG. 2, in the storing section 34, a database relating to word concept (hereinafter referred to as “concept graph 50”) and a database relating to content (hereinafter referred to as “content DB 52”) are constructed, and the picture-print information 54, the derived information 56, and the evaluation result information 58 are stored.

The concept graph 50 is a graph indicating a relation between words (that is, an ontology graph) and is configured by nodes and links (or edges). Coordinate values on an N-dimensional (for example, N≥3) feature space are associated with individual words configuring the nodes. That is, the individual words are quantified as “distributed representation” of natural language processing.

The concept graph 50 includes nouns, adjectives, adverbs, verbs, or compounds made by combining them. Further, not only words that directly represent the form of content (for example, the kind, colors, shape, pattern, or the like of an object) but also words indicating conceptual or notional impression including emotions and a mental state may be registered in the concept graph 50. Moreover, not only words routinely used but also words that are not routinely used (for example, fictional object or a kind of creation step) may be included in the concept graph 50. In addition, the concept graph 50 may be made for each of the kinds of languages such as Japanese, English, and Chinese. By using the concept graphs 50 in a distinguished manner, cultural differences from country to country or from region to region can be reflected more elaborately.

In the content DB 52, [1] the content data D1, [2] the related data D2, and [3] information generated by using the content data D1 or the related data D2 (hereinafter “generated information”) are registered in association with each other. The “generated information” includes the picture-print information 54, the derived information 56, and the evaluation result information 58.

The content data D1 is an aggregate of content elements configuring content, and is configured to be capable of expressing the creation process of the content. For example, the content data D1 is formed of ink data (“digital ink”) which represents content created based on handwriting. “Ink description languages” for describing the digital ink include, for example, Wacom Ink Layer Language (WILL), Ink Markup Language (InkML), and Ink Serialized Format (ISF). The content may be an artwork (or digital art) including a picture, a calligraphic work, illustrations, text characters, and so forth, for example.

The related data D2 includes various pieces of information relating to creation of content. The related data D2 include, for example, [1] creator information including identification information, attributes, and so forth of the content creator, [2] “setting conditions on the device driver side” including the resolution, the size, and the kind of the display 24; the detection performance, the kind, and the shape of a writing pressure curve of the touch sensor 25; and so forth, [3] “setting conditions of the drawing application side” including the kind of content, color information of a color palette and a brush, and setting of visual effects, [4] “operation history of the creator” sequentially stored through execution of a drawing application, [5] “biological data” indicating a biological signal of the creator at the time of creation of the content, [6] “environmental data” indicating the state of the external environment at the time of creation of the content, or the like.

The picture-print information 54 includes a picture-print defined on the above-described feature space or a processed picture-print. Here, the “picture-print” means a set or a trace of points in the feature space which represent the state feature amount. Examples of the “processed picture-print”include a picture-print resulting from reduction in the number of dimensions (that is, a sectional view), a picture-print resulting from decimation of the number of points, and so forth. The picture-print information 54 is stored in association with the above-described creator information, specifically, identification information of content or a creator.

The derived information 56 is information derived from the picture-print information 54 and includes, for example, visible information configured to provide inspiration to the content creator (hereinafter referred to as “inspiration information”). Examples of the inspiration information include [1] a word group as the state feature amount, and [2] another representation obtained by making a word included in the word group abstract or indirect (for example, a symbol indicating a strength of characteristics, another word with high similarity, or the like). The derived information 56 is stored in association with the creator information (specifically, identification information of content or a creator) similarly to the picture-print information 54.

The evaluation result information 58 indicates the evaluation result of content by the content evaluating section 44. Examples of the evaluation result include [1] the result of a single-entity evaluation including a classification category, a score, a creation step, and so forth, and [2] the result of a comparative evaluation including the degree of similarity, authenticity determination, and so forth.

### Functional Block Diagram of Feature Calculating Section 42

FIG. 3 is a detailed functional block diagram of the feature calculating section 42 illustrated in FIG. 2. The feature calculating section 42 functions as a data shaping section 60, a rasterization processing section 62, a word converting section 64, a data integrating section 66, a state feature calculating section 68 (corresponding to a “first calculating section”), and an operation feature calculating section 70 (corresponding to a “second calculating section”).

The data shaping section 60 executes shaping processing on the content data D1 and the related data D2 acquired by the data acquiring section 40 and outputs shaped data (hereinafter, referred to as “non-raster data”). Specifically, the data shaping section 60 executes [1] association processing to associate the content data D1 and the related data D2 with each other, [2] giving processing to give order to a series of operations in the creation period of content, and [3] removal processing to remove unnecessary data. Examples of the “unnecessary data” include [1] operation data relating to a user operation canceled in the creation period, [2] operation data relating to a user operation that does not contribute to the completion of the content, [3] various kinds of data in which consistency is not recognized as a result of the above-described association processing, and so forth.

The rasterization processing section 62 executes “rasterization processing” to convert vector data included in the content data D1 acquired by the data acquiring section 40 to raster data. The vector data means stroke data indicating the form of a stroke (for example, shape, thickness, color, and so forth). The raster data means image data composed of multiple pixel values.

The word converting section 64 executes data conversion processing to convert input data to one or two or more words (hereinafter referred to as a word group). The word converting section 64 includes a first converter for outputting a first word group and a second converter for outputting a second word group.

The first converter is configured of a learner that inputs (receives) the raster data from the rasterization processing section 62 and outputs tensor data indicating the detection result of an image (i.e., an existence probability relating to the kind and the position of an object). The learner may be constructed by a convolutional neural network (for example, “Mask R-CNN” or the like) for which machine learning has been executed, for example. The word converting section 64 refers to graph data 72 that describes the concept graph 50 and decides, from among word groups indicating the kind of object detected by the first converter, a word group registered in the concept graph 50 as the “first word group.”

The second converter is configured of a learner that inputs (receives) the non-raster data from the data shaping section 60 and outputs the score of each word. The learner may be constructed by a neural network (for example, “LightGBM,” “XGBoost,” or the like) for which machine learning has been executed, for example. The word converting section 64 refers to the graph data 72 that describes the concept graph 50 and decides, from among word groups converted by the second converter, a word group registered in the concept graph 50 as the “second word group.”

The data integrating section 66 integrates data (more specifically, the first word group and the second word group) of each operation sequentially obtained by the word converting section 64. This operation is a “stroke operation” for drawing one stroke but may be various user operations that can affect creation of content additionally or alternatively to the stroke operation. Further, the integration may be executed in units of each operation or may be executed in units of multiple consecutive operations.

The state feature calculating section 68 calculates the feature amount relating to the drawing state of content created through a series of operations (hereinafter referred to as a “state feature amount”) in a time-series manner at least based on both the raster data and the stroke data of the content. The time series of the state feature amounts corresponds to the “picture-print” that is a pattern specific to the content. For example, the state feature amount may be [1] the kind and the number of words configuring a word group or [2] a coordinate value in the feature space defined by the concept graph 50. Alternatively, the state feature calculating section 68 may identify the kind of language from the content data D1 or the related data D2 and calculate the time series of the state feature amounts by using the concept graph 50 corresponding to the kind of language.

The operation feature calculating section 70 uses the time series of the state feature amounts calculated by the state feature calculating section 68 to obtain the amount of change in the state feature amount between before and after a single or consecutive operations, and calculates the operation feature amount relating to the operation from the amount of change in a time-series manner. The time series of the operation feature amounts corresponds to the “picture-print” that is a pattern specific to the content. For example, the operation feature amount is a magnitude or a direction of a vector that has a first drawing state as the initial point immediately before execution of one operation and has a second drawing state as the terminal point immediately after the execution of the one operation.

### Description of First Operation: Calculation of Feature Information

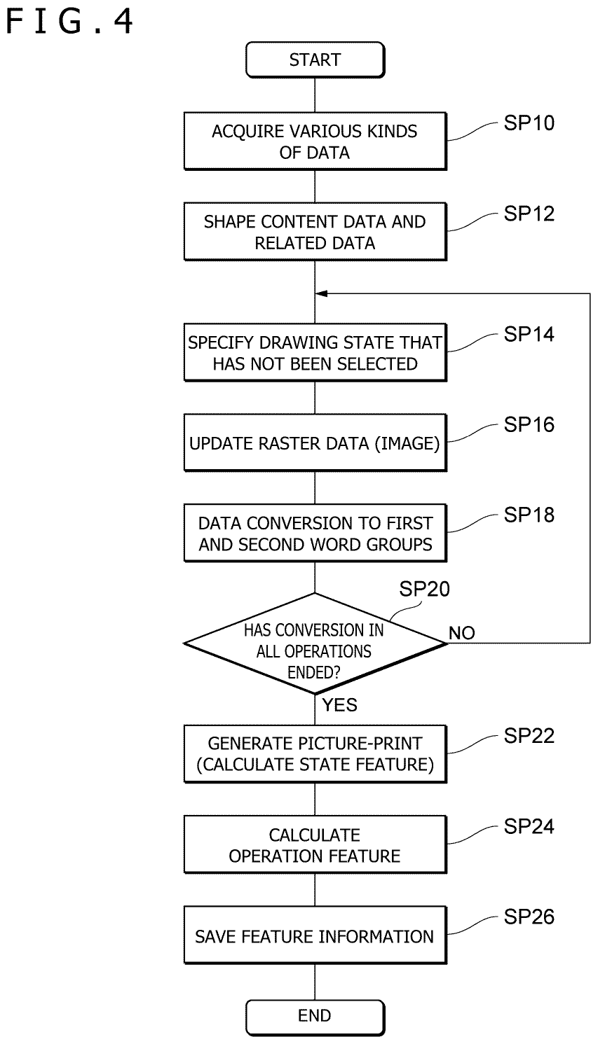

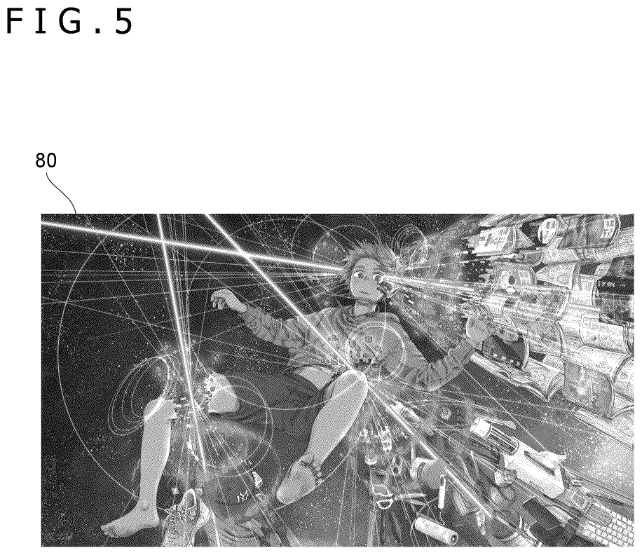

The content evaluation system 10 in this embodiment is configured as above. Description will be made about a first operation of the content evaluation system 10, specifically, a calculation operation of feature information by the server device 16 which forms part of the content evaluation system 10, with reference to the functional block diagram of FIG. 3, a flowchart of FIG. 4, and FIGS. 5-12.

In step SP10 of FIG. 4, the data acquiring section 40 acquires various kinds of data relating to content of an evaluation target, for example, at least one of the content data D1 and the related data D2.

FIG. 5 is a diagram illustrating one example of content created by using the user device 12 of FIG. 1. The content of this diagram is an artwork 80 created by handwriting. The creator of the content completes the desired artwork 80 using the user device 12 and the electronic pen 14. The artwork 80 is created through a series of operations by the creator or multiple kinds of creation steps.

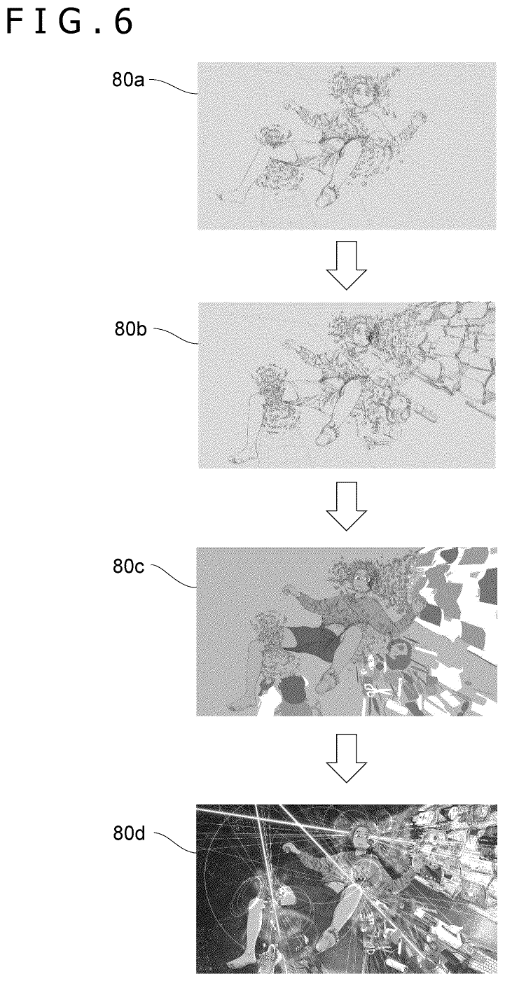

FIG. 6 is a diagram illustrating the transition of the drawing state of the artwork 80 in FIG. 5. A first in-progress work 80a indicates the drawing state of a “composition step” in which the overall composition is settled. A second in-progress work 80b indicates the drawing state of a “line drawing step” in which a line drawing is made. A third in-progress work 80c indicates the drawing state of a “coloring step” in which color painting is executed. A fourth in-progress work 80d indicates the drawing state of a “finishing step” for finishing.

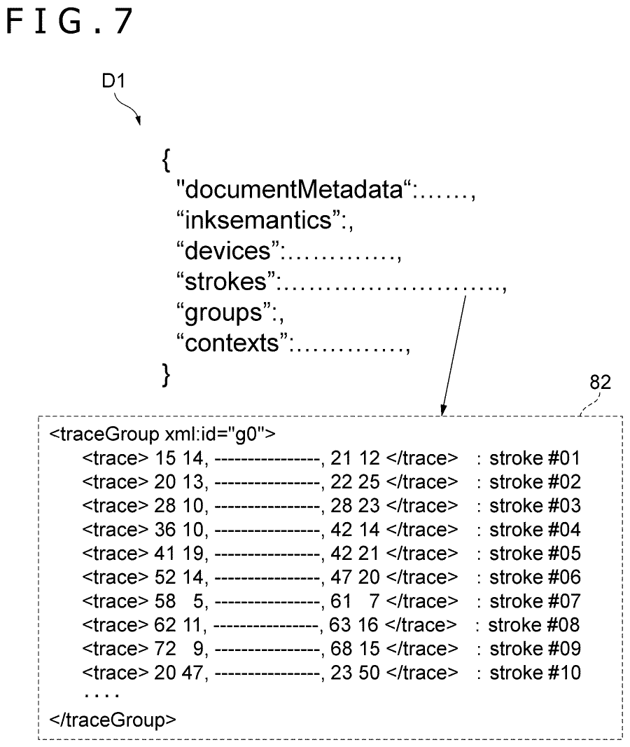

FIG. 7 is a diagram illustrating one example of a data structure of the content data D1 in FIGS. 1 and 2. In the example of this diagram, the case in which the content data D1 is digital ink is illustrated. The digital ink has a data structure obtained by sequentially arranging [1] document metadata (document Metadata), [2] semantic data (ink semantics), [3] device data (devices), [4] stroke data (strokes), [5] classification data (groups), and [6] context data (contexts).

Stroke data 82 is data describing individual strokes forming content made by handwriting, and indicates the shape of the strokes forming the content and the order of writing of the strokes. As is understood from FIG. 7, one stroke is described by multiple pieces of point data sequentially arranged in <trace> tags. Each point data is composed of at least an indicated position (X-coordinate, Y-coordinate) and is marked off by a delimiter such as a comma. For convenience of illustration, only the point data indicating the start point and the end point of the stroke are represented, and the respective pieces of point data indicating multiple passing points are omitted. In this point data, besides the above-described indicated position, the order of generation or editing of the stroke, the writing pressure and the posture (orientation) of the electronic pen 14, and so forth may be included.

In step SP12 of FIG. 4, the data shaping section 60 executes shaping processing on the content data D1 and the related data D2 acquired in step SP10. By this shaping, data that is not the raster format (hereinafter referred to also as “non-raster data”) is associated per each stroke operation.

In step SP14, the feature calculating section 42 specifies one drawing state that has not yet been selected in the creation period of the content. The feature calculating section 42 specifies the drawing state resulting from execution of the first stroke operation in the first round of the processing.

In step SP16, the rasterization processing section 62 executes rasterization processing to reproduce the drawing state specified in step SP14. Specifically, the rasterization processing section 62 executes drawing processing to add one stroke to the most recent image. This updates the raster data (an image) that is the conversion target.

In step SP18, the word converting section 64 converts the respective data made in steps SP14 and SP16 to word groups composed of one or two or more words. Specifically, the word converting section 64 converts the raster data from the rasterization processing section 62 to the first word group and converts the non-raster data from the data shaping section 60 to the second word group. The word converting section 64 refers to the graph data 72 that describes the concept graph 50 when executing [1] the conversion of the raster data and [2] the conversion of the non-raster data.

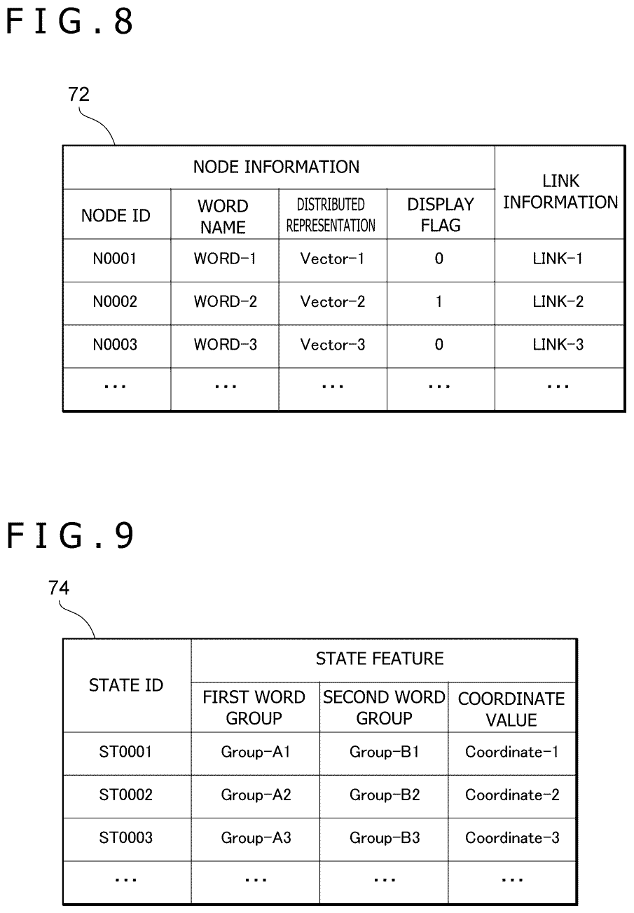

FIG. 8 is a diagram illustrating one example of a data structure of the graph data 72 in FIG. 3. This graph data 72 is data of a table format indicating a correspondence relation between “node information” relating to nodes forming the graph and “link information” relating to links forming the graph. The node information includes, for example, a node identification (ID), the word name, distributed representation (coordinate value in the feature space), and a display flag. The link information includes whether or not the link between nodes exists and a label given to each link.

In step SP20 of FIG. 4, the feature calculating section 42 checks whether or not the data conversion in all stroke operations has been completed. Because the conversion has not yet ended in the first round of the processing (step SP20: NO), the feature calculating section 42 returns to step SP14.

In step SP14, the feature calculating section 42 specifies the drawing state resulting from execution of the second stroke operation in the second round of the processing. In the following description, the feature calculating section 42 sequentially repeats the operation of steps SP14 to SP20 until the data conversion in all drawing states is completed. While this operation is repeated, the data integrating section 66 aggregates and integrates data regarding every stroke operation. Thereafter, when the data conversion in all stroke operations has been completed (step SP20: YES), the processing proceeds to the next step SP22.

In step SP22, the state feature calculating section 68 calculates the time series of the state feature amounts by using the integrated data integrated through the execution of steps SP14 to SP20. This generates first picture-print data indicating a first picture-print.

FIG. 9 is a diagram illustrating one example of a data structure of the picture-print data 74. The picture-print data 74 is data of a table format indicating a correspondence relation between a “state ID” that is identification information of the drawing state of the artwork 80 and the “state feature (amount)” relating to the drawing state. The state feature amount includes, for example, the first word group, the second word group, and a coordinate value. The coordinate value is defined in an N-dimensional feature space 90. The number N of dimensions is an integer equal to or larger than three, and it is desirable that the number N be a numerical value on the order of several hundreds.

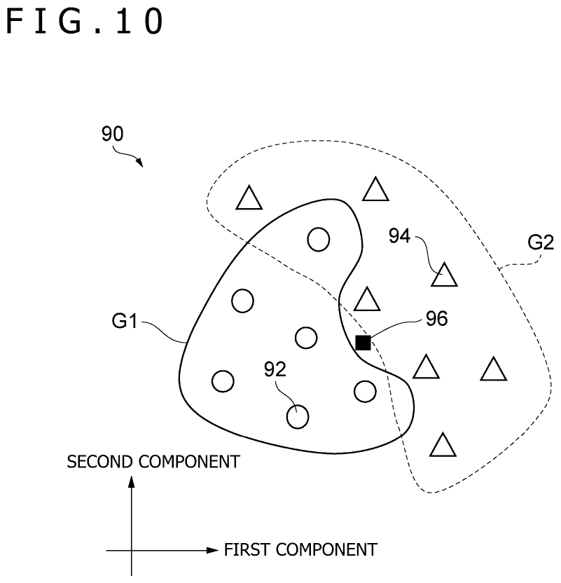

FIG. 10 is a diagram illustrating one example of the calculation method of the state feature (or “state feature amount”). The feature space 90 is represented in a plane coordinate system in which a first component and a second component are indicated on two axes for convenience of illustration. A word group G1 corresponding to the first word group is composed of multiple (six in the example of this diagram) words 92. A word group G2 corresponding to the second word group is composed of multiple (seven in the example of this diagram) words 94.

Here, the state feature calculating section 68 obtains the union of the two word groups G1 and G2 and calculates the coordinate value of a representative point 96 of the set of points as the feature amount of the drawing state (that is, a state feature amount). The state feature calculating section 68 may obtain the union by using all words that belong to the word groups G1 and G2 or obtain the union after excluding words with a low degree of association with the other words (specifically, independent nodes without a link). Further, for example, the state feature calculating section 68 may identify the centroid of the set of points as the representative point 96 or identify the representative point 96 by using another statistical method.

In step SP24 of FIG. 4, the operation feature calculating section 70 calculates the time series of the operation feature amounts by using the time series of the state feature amounts calculated in step SP22. This generates second picture-print data indicating a second picture-print. For example, the second picture-print data is data of a table format indicating a correspondence relation between a “stroke ID” that is identification information of a stroke operation and the “operation feature amount” relating to each stroke operation. The operation feature amounts include, for example, a usage-increased word, a usage-decreased word, and a change amount. The displacement amount is defined in the N-dimensional feature space 90, similarly to the “coordinate value” of FIG. 9.

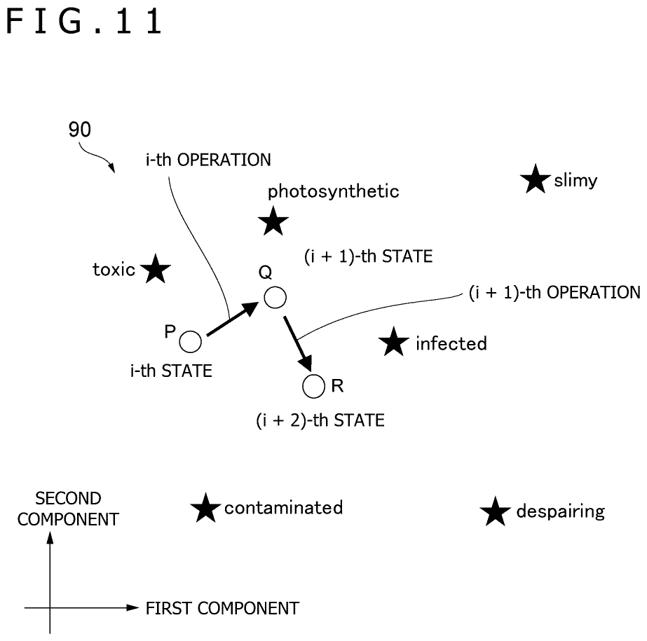

FIG. 11 is a diagram schematically illustrating one example of the calculation method of the operation feature amount. The feature space 90 is represented in a plane coordinate system in which a first component and a second component are indicated on two axes, as in the case of FIG. 10, for convenience of illustration. Star marks in this diagram indicate the positions of words defined by the concept graph 50 (what is generally called distributed representation). Circle marks in this diagram indicate the positions of the drawing states (that is, state feature amounts).

For example, suppose that a transition is made to the (i+1)-th drawing state by executing the i-th stroke operation from the i-th drawing state. In this case, a vector (or displacement amount) that has a position P as the initial point and has a position Q as the terminal point corresponds to the i-th operation feature amount. Similarly, a vector (or a displacement amount) that has the position Q as the initial point and has a position R as the terminal point corresponds to the (i+1)-th operation feature amount.

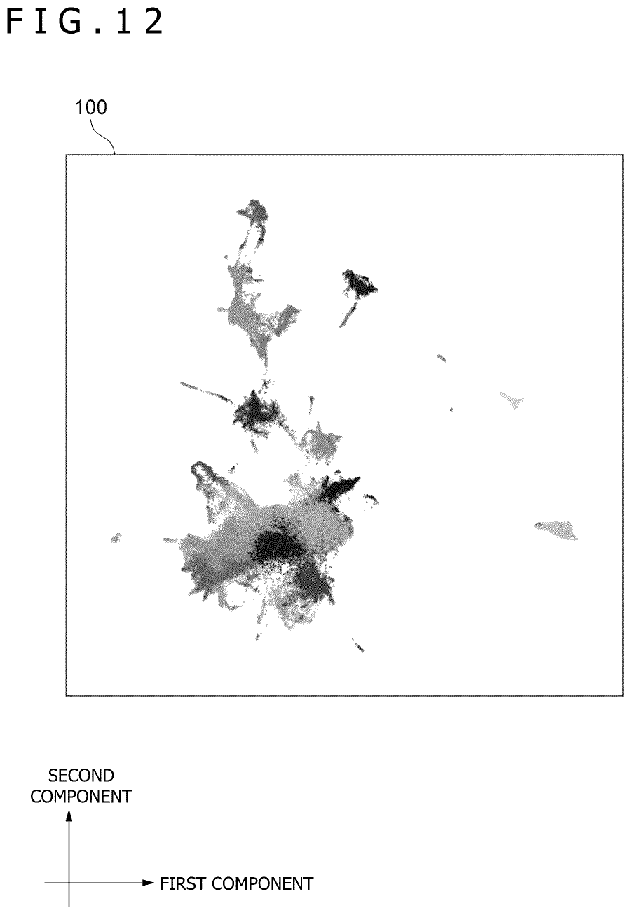

FIG. 12 is a diagram illustrating one example of a picture-print 100 that is made visible. A feature space is represented in a plane coordinate system in which a first component and a second component are indicated on two axes, as in the cases of FIG. 10 and FIG. 11, for convenience of illustration. The picture-print 100 of this diagram indicates a series of creation processes from the start timing to the end timing of creation of the artwork 80. More specifically, the picture-print 100 is an aggregate of the representative points 96 (FIG. 10) calculated for every stroke operation. Although the picture-print 100 is represented as a set of points in the feature space in the example of this diagram, the picture-print 100 may instead be one line (that is, a trace) obtained by sequentially linking the respective points.

In step SP26 of FIG. 4, the feature calculating section 42 saves the feature information calculated in steps SP22 and SP24. Specifically, the feature calculating section 42 supplies the first picture-print data and the second picture-print data to the storing section 34 in the state in which these pieces of data are associated with the content or the creator. This causes the first picture-print data and the second picture-print data to be each registered in the content DB 52 in an available state. Through the above, the server device 16 ends the operation illustrated in the flowchart of FIG. 4.

### Description of Second Operation: Reproduction Display Operation of Content

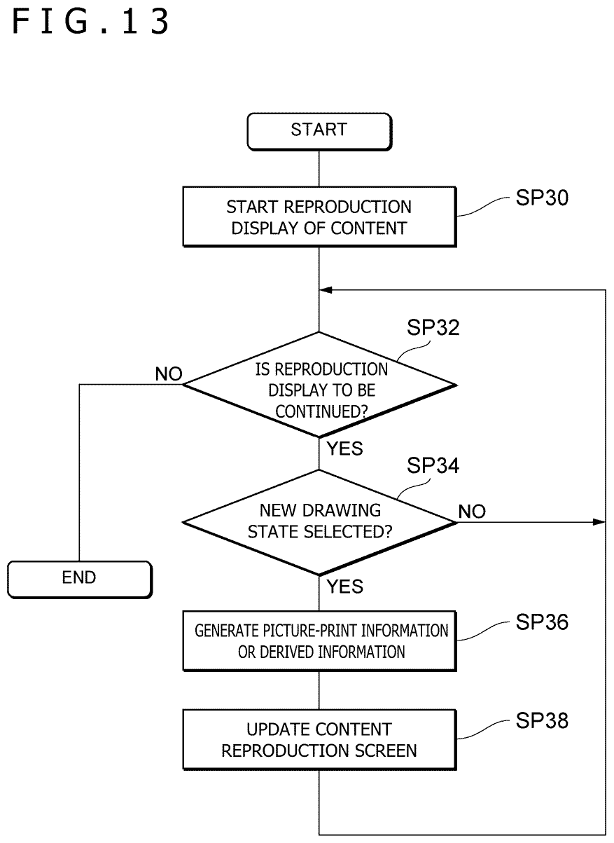

Subsequently, description will be made about a second operation of the content evaluation system 10, specifically, a reproduction display operation of content using the user device 12 and the server device 16, with reference to a flowchart of FIG. 13 and FIGS. 14-20. In this operation, a user is a creator or a viewer of the content.

### Overall Operation

In step SP30 in FIG. 13, the user device 12, in response to the user operation, starts reproduction display of the content. Prior to the display, the user device 12 transmits request data including creator information to the server device 16. After receiving the request data from the user device 12, the server device 16 reads out and acquires various kinds of information relating to an artwork 110 associated with the creator information from the content DB 52. Thereafter, the display instructing section 48 of the server device 16 transmits, to the corresponding user device 12, the presentation data D3 including the acquired various kinds of information (specifically, content data D1, picture-print information 54, derived information 56, evaluation result information 58, or the like).

The processor 21 of the user device 12 generates a display signal by using the presentation data D3 received from the server device 16 and supplies the display signal to the display 24. This causes a content reproduction screen 108 to be made visible and be displayed in a display region of the display 24.

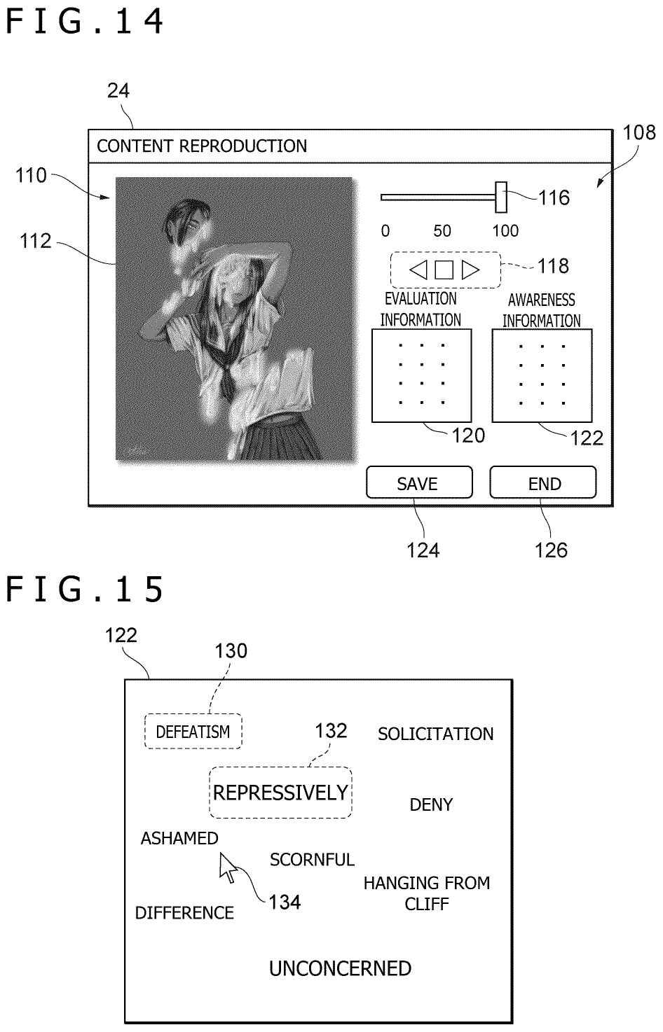

FIG. 14 is a diagram illustrating one example of the content reproduction screen 108 displayed on the display 24 of FIG. 1. The following elements are arranged on the content reproduction screen 108: a drawing display field 112 indicating the drawing state of the artwork 110, user controls 116 and 118 relating to selection of the drawing state, an information presentation field 120 for presenting the picture-print information 54 or the evaluation result information 58, an information presentation field 122 for presenting the derived information 56, a button 124 on which [SAVE] is represented, and a button 126 on which [END] is represented.

The user control 116 is configured of, for example, a slide bar and is set to allow selection of the degree of completion (any value between 0 to 100%) of the artwork 110. The user control 118 is configured of, for example, multiple buttons and is set to allow execution of various operations relating to reproduction of the creation process of the artwork 110. The [SAVE] button 124 is equivalent to a user control for saving a captured image of the content reproduction screen 108. The [END] button 126 corresponds to a user control for ending display of the content reproduction screen 108.

In step SP32 of FIG. 13, the processor 21 of the user device 12 checks whether or not to continue the reproduction display of the content. In the initial state, end operation has not yet been executed (step SP32: YES). Thus, the processor 21 proceeds to the next step SP34.

In step SP34, the processor 21 of the user device 12 checks whether or not a new drawing state has been selected. In the initial state, the drawing state is fixed at “degree of completion=0%” (step SP34: NO). Thus, the processor 21 returns to step SP32 and sequentially repeats steps SP32 and SP34 until a drawing state other than 0% is selected.

For example, when a user has executed an operation of selecting “degree of completion=50%” through the user control 116 in FIG. 14, the processor 21, using the selection of the new drawing state as a trigger, proceeds to the next step SP36 (step SP34: YES).

In step SP36, the processor 21 of the user device 12 acquires various kinds of information corresponding to the drawing state newly selected in step SP34. Prior to this acquisition, the user device 12 transmits request data including creator information and input information to the server device 16. After receiving the request data from the user device 12, the server device 16 reads out and acquires various kinds of information relating to an artwork 110 associated with the creator information from the content DB 52. Thereafter, the information generating section 46 of the server device 16 generates the picture-print information 54 or the derived information 56 according to the degree of completion (for example, 50%) identified from the input information. Subsequently, the new presentation data D3 is provided to the user device 12 by operation similar to that of the case of step SP30.

In step SP38, the processor 21 of the user device 12 updates the content of display of the content reproduction screen 108 by using the various kinds of information acquired in step SP36. This causes each of the drawing display field 112 and the information presentation fields 120 and 122 to be updated according to the drawing state (that is, the degree of completion) of the artwork 110.

Thereafter, the processing returns to step SP32, and the processor 21 of the user device 12 repeats the operation of steps SP32 to SP38 until the user input of an end command. For example, in response to receiving a touch operation of the [SAVE] button 124 in FIG. 14, the processor 21 saves the content of the content reproduction screen 108 displayed at the current timing as a captured image. Meanwhile, the processor 21 ends the operation of the flowchart illustrated in FIG. 13 in response to receiving user operation of the [END] button 126 in FIG. 14.

As described above, the user device 12 may display the picture-print information 54, the derived information 56, or the evaluation result information 58 in conjunction with the artwork 110. In particular, the “inspiration information,” which is one mode of the derived information 56, is made visible and displayed. This makes it possible to prompt the user to make a new discovery or interpretation regarding the artwork 110, where a new inspiration is given to the creator. As a result, a “positive spiral” of creation activities of art is generated.

### First Example

FIG. 15 is a diagram illustrating a first example of inspiration display. In the information presentation field 122, multiple character strings 130 and 132 are randomly arranged. The character string 130 indicates one word composed of characters having a normal size. The character string 132 indicates one word composed of characters having a size larger than the normal size. For example, when the state feature amount is a word group, the usage frequency of words from the current drawing state to the n-th (n≥2) drawing state prior to the current drawing state is obtained, and words with a relatively high frequency are displayed in larger font. In the example of this diagram, two character strings 132, more specifically, “repressively” and “unconcerned,” are displayed in a larger size.

By displaying a word group associated with the drawing state of the artwork 110 in conjunction with the artwork 110 in this manner, the user can grasp words represented in the word group at a glance to deepen the user's feeling or impression for the creation of the artwork 110.

### Second Example

Suppose that a user visually recognizes the information presentation field 122 of FIG. 15 and executes operation of adjusting a cursor 134 to the position of a word in which the user is interested (here, “ashamed”). In this case, the drawing display field 112, which is part of the content reproduction screen 108 of FIG. 14, is automatically updated.

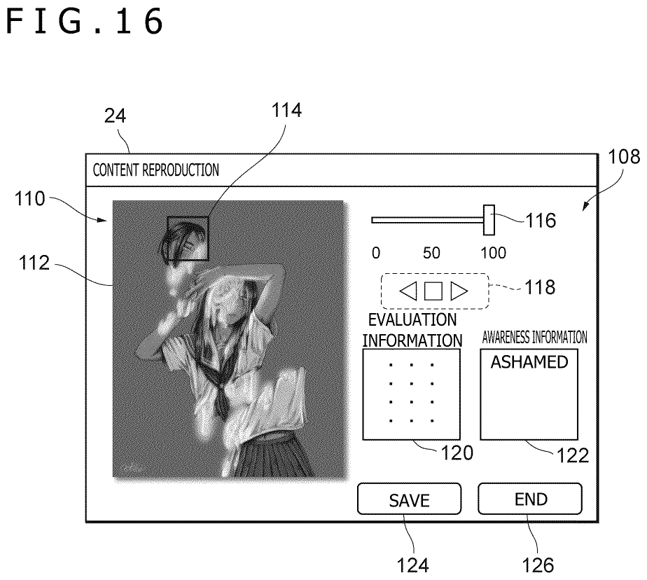

FIG. 16 is a diagram illustrating a second example of the inspiration display. In this content reproduction screen 108, the content of the drawing display field 112 is different compared to the screen illustrated in FIG. 14. Specifically, a rectangular frame 114 is arranged to overlap with a position corresponding to a face region indicating the “face” of the person in the artwork 110. The position and the shape of the rectangular frame 114 are set depending on the output result from the word converting section 64 in FIG. 3 (more specifically, tensor data from the first converter). The user can associate “ashamed” with “face” by viewing the drawing display field 112 and the information presentation field 122 simultaneously. That is, it is suggested that the “face” has been drawn under a subconscious feeling of being “ashamed.”

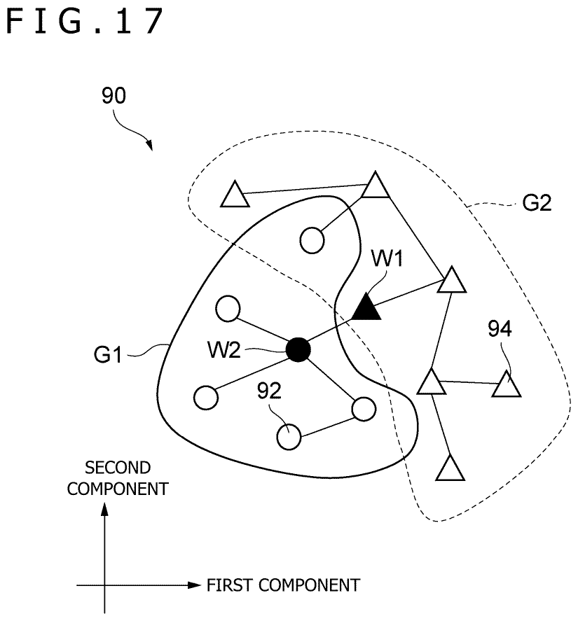

FIG. 17 is a diagram illustrating one example of the selection method of a directly related word. The feature space 90 is represented in a plane coordinate system in which a first component and a second component are indicated on two axes, as in the case of FIG. 10. The word group G1 is composed of six words 92, and the word group G2 is composed of seven words 94. Here, line segments that link the words 92 and 94 to each other correspond to the “links” defined by the concept graph 50. A specified word W1 is a word that [1] belongs to the word group G2 and [2] is specified by the information presentation field 122. A related word W2 is a word that [1] belongs to the word group G1, [2] has a connection relation with the specified word W1, and [3] has the smallest number of links. For example, the related word W2 (word “face”) corresponding to the specified word W1 (word “ashamed”) is uniquely selected according to the above-described selection rule.

By displaying the mark (here, a rectangular frame 114) that partially highlights the position (here, a boundary box surrounding the “face” region) corresponding to the state feature amount (here, a word “ashamed”) in the display region of the artwork 110 in this manner, the user can recognize the place in the artwork 110 serving as the basis of the state feature amount and more easily associate the drawing state with the state feature amount.

### Third Example

Suppose that a user visually recognizes the drawing display field 112 in FIG. 14 and executes an indication operation of indicating the position of an image part (for example, the “face” region) in which the user is interested. In this case, the information presentation field 122, which is part of the content reproduction screen 108 in FIG. 14, is automatically updated. While in the second example above, a directly related word is selected, in the third example, an indirectly related word is selected.

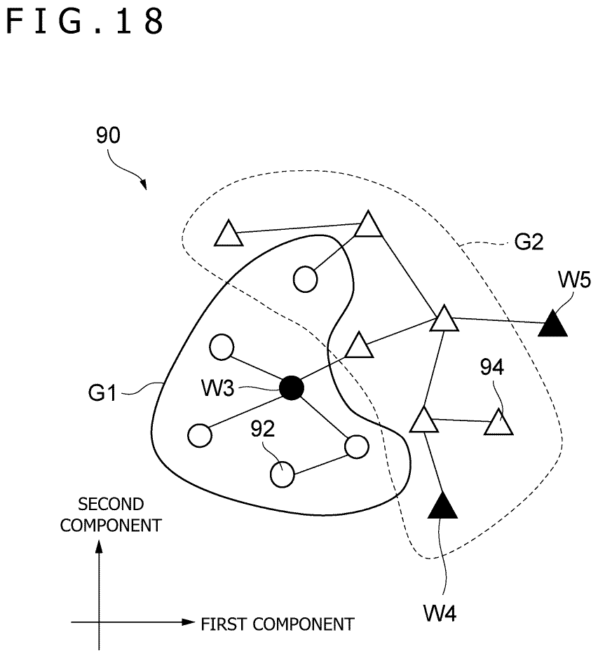

FIG. 18 is a diagram illustrating one example of the selection method of an indirectly related word in the third example of the inspiration display. The feature space 90 is represented in a plane coordinate system in which a first component and a second component are indicated on two axes, as in the case of FIG. 17. Line segments that link the words 92 and 94 to each other correspond to the “links” defined by the concept graph 50, as in the case of FIG. 17. Further, star marks in this diagram indicate words regarding which the “display flag” in the graph data 72 (FIG. 8) is in the on-state (flag value is 1), that is, words included in selection candidates for the “inspiration display.”

A specified word W3 is a word that [1] belongs to the word group G1 and [2] corresponds to a position in an image region specified by the drawing display field 112. A related word W4 is a word that [1] belongs to the word group G2, [2] has a connection relation with the specified word W3, and [3] has the display flag in the on-state. A related word W4 is a word that [1] does not belong to the word group G1, [2] has a connection relation with the specified word W3, [3] has the display flag in the on-state, and [4] has the smallest number of links. For example, the related word W4 (or related word W5) corresponding to the specified word W3 (word “face”) is selected according to the above-described selection rule.

When the directly related word W2 with respect to the specified word W1 is presented to the user as in the second example, it becomes easier to associate the drawing state with the state feature amount, though a strong bias tends to be given to the user. Thus, by presenting the indirectly related words W4 and W5 with respect to the specified word W3 to the user, the relation between the drawing state and the state feature amount is indirectly suggested. This can give a new inspiration to the creator without unconsciously narrowing the scope of new discovery and interpretation.

### Fourth Example

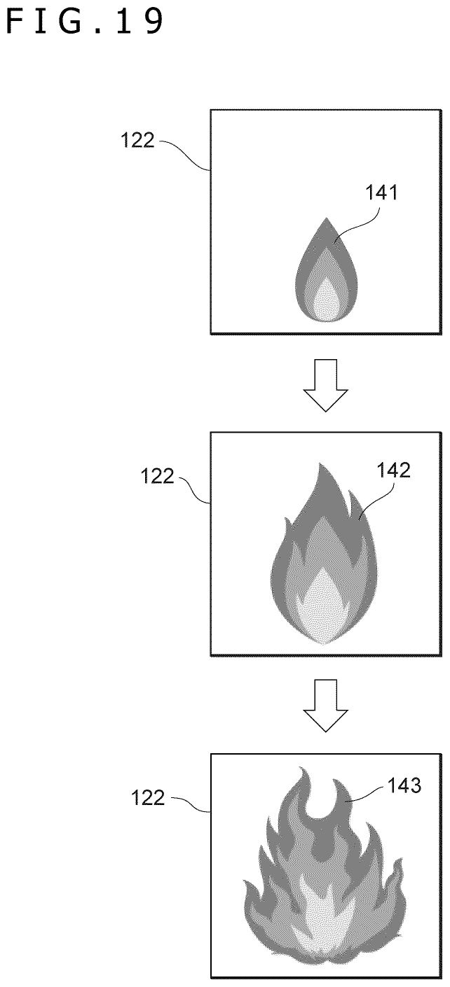

FIG. 19 is a diagram illustrating a fourth example of the inspiration display. In the information presentation field 122, a symbol 141, 142, or 143 indicating a flame is disposed. The symbols 141 to 143 have different forms according to the strength of a characteristic that a word has. The “characteristic” means a conceptual or notional impression including emotions and a mental state. For example, the “flame” is a symbol that evokes “passion.” Therefore, when using a word which evokes “a state in which passion is weak,” the symbol 141 indicating a flame with low heat is selected. When using a word which evokes “a state in which passion is medium,” the symbol 142 indicating a flame with medium heat is selected. When using a word which evokes “a state in which passion is strong,” the symbol 143 indicating a flame with high heat is selected.

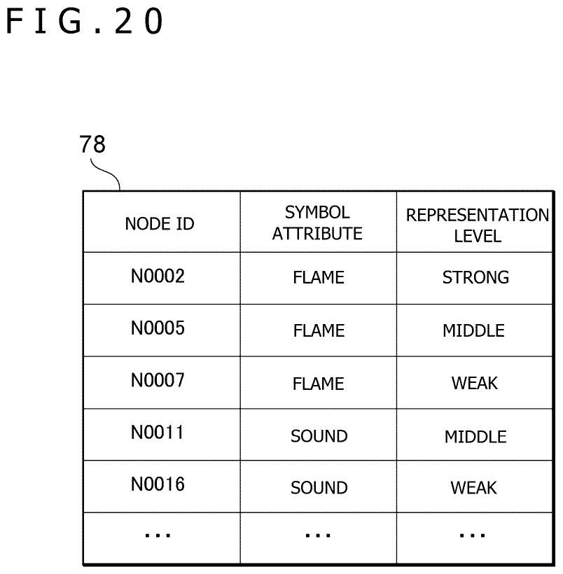

FIG. 20 is a diagram illustrating one example of a data structure of representation conversion data 78. The representation conversion data 78 is data of a table format indicating the correspondence relation among a “node ID” that is identification information of the node configuring a graph, a “symbol attribute” indicating the attribute of a symbol, and a “representation level” indicating the degree of representation. The node ID is given according to the same definition as that of the case of the graph data 72 illustrated in FIG. 8. Examples of the symbol attribute include, besides flame and sound, various kinds of symbols that can represent the “strength” in stages such as water, wind, radio wave, and so forth. The representation level is not limited to the three levels of the strong, medium, and weak levels, and two or four or more levels may be set.

The information generating section 46 (FIG. 3) of the server device 16 reads out and refers to the graph data 72 of FIG. 8 and the representation conversion data 78 of FIG. 20, to identify [1] the node ID, [2] the symbol attribute, and [3] the representation level, of a word to be displayed as a symbol, and then creates or acquires image data indicating the corresponding symbol. The user device 12 can display the symbols 141 to 143 in the information presentation field 122 by using the image data included in the received presentation data D3.

By presenting, to the user, the symbols 141 to 143 indicating the strength of a characteristic possessed by a word as an indirect representation of the word in this manner, the relation between the drawing state and the state feature is indirectly suggested. This can give a new inspiration to the creator or the viewer without unconsciously narrowing the scope of new discovery and interpretation.

### Summary of Embodiments

As described above, the content evaluation system 10 in the above embodiments include one or multiple user devices 12 having the display section (“display 24”) that displays an image or video and the content evaluation device (“server device 16”) configured to be capable of communicating with each user device 12.

The server device 16 includes the feature calculating section 42 that calculates the state feature amount relating to the drawing state in the creation period from the start timing to the end timing of creation of the content (artwork 80 or 110) and the display instructing section 48 that instructs display of the picture-print 100 that is a set or a trace of points in the feature space 90 which represents the state feature calculated by the feature calculating section 42 or the derived information 56 derived from the picture-print 100.

According to a content evaluation method and a program in the embodiments, one or in multiple processors (or computers) execute a calculation step of calculating the state feature amount relating to the drawing state in the creation period from the start timing to the end timing of creation of the artwork 80 or 110 (SP22 in FIG. 4) and an instruction step of instructing display of the picture-print information 54 indicating the picture-print 100 that is a set or a trace of points in the feature space 90 which represents the calculated state feature or the derived information 56 derived from the picture-print 100 (SP30 and SP38 in FIG. 13).

By displaying the picture-print information 54 indicating the picture-print 100 or the derived information 56 derived from the picture-print 100 in conjunction with the artwork 80 or 110 as described above, it is possible to provide effective inspiration leading to the next creation to the users including the creator and the viewer of the content.

The derived information 56 may be the inspiration information which provides inspiration to the creator or the viewer of the artwork 80 or 110. The inspiration information may include visible information obtained by making a word corresponding to the state feature amount abstract or indirect. The visible information may include the symbols 141 to 143 indicating the strength of a characteristic of the word. Alternatively, the visible information may include another word (related word W2, W4, or W5) relating to the word (specified word W1 or W3). The other word may be an abstract word having an abstract meaning.

When the state feature amount is a word group composed of one or multiple words, the feature calculating section 42 may convert raster data of the artwork 80 or 110 to the first word group and convert stroke data of the artwork 80 or 110 to the second word group and calculate the state feature amount by synthesizing the first word group and the second word group.

### Modification Examples

It is obvious that the present disclosure is not limited to the above-described embodiments and can be freely modified according to the principles disclosed herein. Alternatively, the respective configurations may optionally be combined in a range in which no technical contradiction is caused. Alternatively, the order of execution of the respective steps forming the flowcharts may be changed in a range in which no technical contradiction is caused.

1. A content evaluation device, comprising:
a feature calculating section which, in operation, calculates a state feature amount relating to a drawing state in a creation period from a start timing to an end timing of creation of content; and
a display instructing section which, in operation, instructs displaying of picture-print information indicating a picture-print, which is a set or a trace of points in a feature space for representing the state feature amount calculated by the feature calculating section, or displaying of derived information derived from the picture-print.

2. The content evaluation device according to claim 1, wherein
the derived information is inspiration information for giving inspiration to a creator or a viewer of the content.

3. The content evaluation device according to claim 2, wherein
the inspiration information includes visible information obtained by making a word corresponding to the state feature amount abstract or indirect.

4. The content evaluation device according to claim 3, wherein
the visible information includes a symbol indicating strength of a characteristic of the word.

5. The content evaluation device according to claim 3, wherein
the visible information includes another word relating to the word.

6. The content evaluation device according to claim 5, wherein
the another word is an abstract word having an abstract meaning.

7. The content evaluation device according to claim 1, wherein
the state feature amount is a word group composed of one or multiple words.

8. The content evaluation device according to claim 7, wherein
the feature calculating section, in operation, converts raster data of the content to a first word group, converts stroke data of the content to a second word group, and calculates the state feature amount by synthesizing the first word group and the second word group.

9. The content evaluation device according to claim 1, wherein
the state feature amount has a number of dimensions larger than three, and
the picture-print information is the picture-print resulting from reduction in the number of dimensions to three or less.

10. The content evaluation device according to claim 1, wherein
the display instructing section, in operation, instructs display of the picture-print information or the derived information in association with the content.

11. The content evaluation device according to claim 10, wherein
the derived information is a mark that partially highlights an image region formed by the content, and
the display instructing section, in operation, instructs display of the mark at a position corresponding to the state feature amount.

12. The content evaluation device according to claim 1, further comprising:
a content evaluating section which, in operation, evaluates the content by use of the state feature amount calculated by the feature calculating section, wherein
the derived information includes an evaluation result of the content evaluating section.

13. A non-transitory computer-readable medium including content evaluation program that causes one or multiple computers to execute:
calculating a state feature amount relating to a drawing state in a creation period from a start timing to an end timing of creation of content; and
instructing displaying of picture-print information indicating a picture-print, which is a set or a trace of points in a feature space for representing the state feature amount, or displaying of derived information derived from the picture-print.

14. A content evaluation method executed by one or multiple computers, comprising:
calculating a state feature amount relating to a drawing state in a creation period from a start timing to an end timing of creation of content; and
instructing displaying of picture-print information indicating a picture-print, which is a set or a trace of points in a feature space for representing the state feature amount, or displaying of derived information derived from the picture-print.

15. A content evaluation system, comprising:
a user device having a display section that displays an image or video; and
a server device configured to be capable of communicating with the user device, wherein
the server device includes:
a feature calculating section which, in operation, calculates a state feature amount relating to a drawing state in a creation period from a start timing to an end timing of creation of content, and
a display instructing section which, in operation, instructs the user device to display picture-print information indicating a picture-print, which is a set or a trace of points in a feature space for representing the state feature amount calculated by the feature calculating section, or to display derived information derived from the picture-print.
